(19) United States
(12) Patent Application Publication
(10) Pub. No.: US 2025/0167952 A1
(43) Pub. Date: May 22, 2025

(54) INTER-RRH L1-RSRP MEASUREMENT AND TCI STATE SWITCHING IN FR2 HST DEPLOYMENT

(71) Applicant: APPLE INC., Cupertino, CA (US)

(72) Inventors: Huaning Niu, San Jose, CA (US); Yushu Zhang, Beijing (CN); Yang Tang, San Jose, CA (US); Jie Cui, San Jose, CA (US); Xiang Chen, Beijing (CN); Dawei Zhang, Saratoga, CA (US); Manasa Raghavan, Sunnyvale, CA (US); Qiming Li, Beijing (CN)

(21) Appl. No.: 18/839,313

(22) PCT Filed: Feb. 18, 2022
(86) PCT No.: PCT/CN2022/076805

§ 371 Date: Aug. 16, 2024

(51) Int. Cl. H04L 5/00; H04B 7/06; H04B 17/318

(52) U.S. Cl. CPC H04L 5/005; H04B 7/0626; H04B 7/06964; H04B 17/328

(57) ABSTRACT

Systems and methods provide Layer 1 reference signal received power (L1-RSRP) measurement and transmission configuration indication (TCI) state switching. A cellular communications network determines a plurality transmission reception points (TRPs) configured for high speed train (HST) communication using millimeter wave (mmWave) signals, and generates a synchronization signal block (SSB) index configuration for the plurality TRPs. The SSB index configuration uses non-adjacent SSB indexes between the plurality of TRPs. A user equipment (UE), in response to entering a HST mode, performs L1-RSRP measurement sharing for SSBs received from different TRPs. A scheduling restraint may be used for TCI state switching. Autonomous UL TA adjustment timing may also be used.

### TECHNICAL FIELD

This application relates generally to wireless communication systems, including Layer 1 reference signal received power (L1-RSRP) measurement and transmission configuration indication (TCI) state switching.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates example HST deployments in accordance with one embodiment.

FIG. 2 illustrates an example uni-directional SFN deployment scenario in accordance with one embodiment.

FIG. 3 illustrates example bi-directional SFN deployment scenario in accordance with one embodiment.

FIG. 4 illustrates an example scenario for overlapping SSB due to large propagation delay in accordance with one embodiment.

FIG. 5 illustrates a time division multiplexing (TDM) L1-RSRP measurement of overlapping SSBs in accordance with one embodiment.

FIG. 6 is a flowchart of a method performed by a cellular communications network in accordance with one embodiment.

FIG. 7 is a flowchart of a method for a UE in accordance with one embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In certain scenarios, a UE may move at a high rate of speed while communicating with one or more base stations, transmission reception points (TRPs), or remote radio heads (RRHs). For example, the UE may be on a high speed train (HST). While examples discussed herein are directed to HST scenarios, the disclosed embodiments are not so limited and may be applied to other scenarios such as aircraft (including unmanned air vehicles (UAVs) or urban air mobility (UAM) deployments), spacecraft, or other vehicles. Skilled persons will recognize from the disclosure herein that certain wireless systems (e.g., an NR or 5G network) may include a number of distributed units (DUs) (e.g., edge units (EUs), edge nodes (ENs), radio heads (RHs), smart radio heads (SRHs), RRHs, TRP), etc.) in communication with a number of central units (CUs) (e.g., central nodes, access node controllers (ANCs), etc.), where a set of one or more distributed units in communication with a central unit may define an access node (e.g., a base station gNB, TRP, etc.). A base station or distributed unit may communicate with a set of UEs on downlink (DL) channels (e.g., for transmissions from a base station or to a UE) and uplink (UL) channels (e.g., for transmissions from a UE to a base station or distributed unit). For simplicity herein, base station, TRP, and RRH may be used interchangeably.

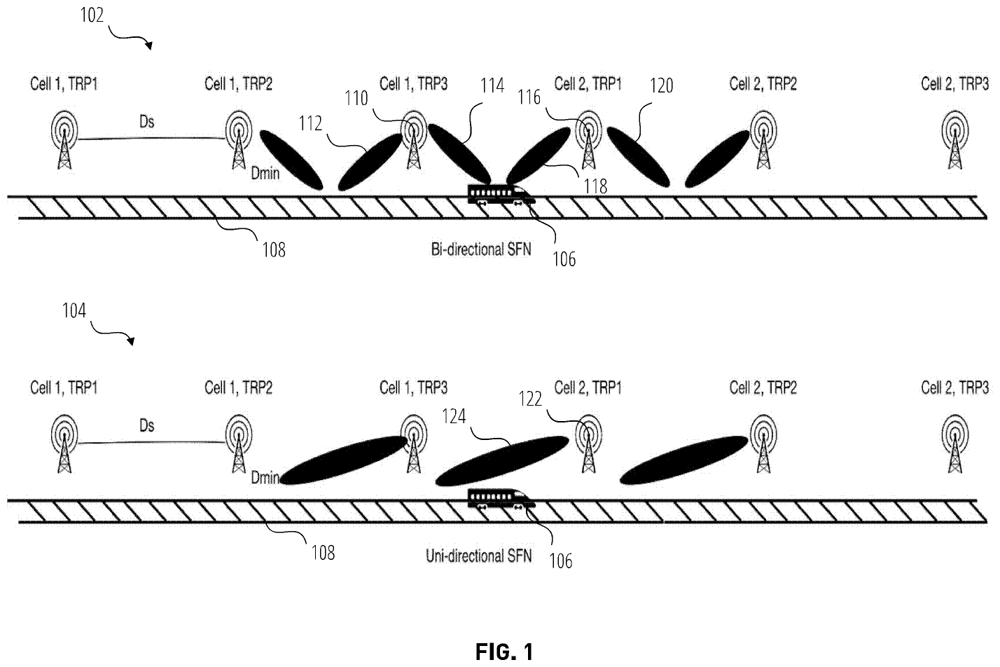

FIG. 1 illustrates example HST deployments according to certain embodiments. Specifically, FIG. 1 shows a bi-directional deployment scenario 102 and a uni-directional deployment scenario 104 using millimeter wave (mmWave) or FR2 communication for single frequency network (SFN) transmissions. For SFN embodiments, the TRPs in the SFN area transmit the same data and reference signals to the HST 106. However, certain embodiments may not use SFN. For example, certain embodiments may use dynamic point switching (DPS) wherein data signals are transmitted from a single TRP at a given time, and the TRP used for transmission is dynamically selected based on the relative quality of channels between the HST 106 and a few closest TRPs.

The examples shown in FIG. 1 include a first cell (Cell 1) with three TRPs (shown as Cell 1, TRP1; Cell 1, TRP2; and Cell 1, TRP3) and a second cell (Cell 2) with three TRPs (shown as Cell 2, TRP1; Cell 2, TRP2; and Cell 2, TRP3). However, any number of cells and/or number of TRPs per cell may be used. A distance between TRPs is shown as distance Ds and a distance from a TRP to the track 108 (or a minimum distance between the TRP and the UE on the passing HST 106) is shown as distance Dmin. In one deployment example, Ds=900 meters (m) and Dmin=150m. In another deployment example, Ds=900m and Dmin=10m such that TRPs may form beams substantially in the direction of the track 108.

Each TRP transmits multiple SSBs with a certain interval and each SSB may be identified by a unique number called an SSB index. Each SSB is transmitted via a specific beam radiated in a certain direction. The UE measures the signal strength of each SSB it detects for a certain period (a period of one SSB set). From the measurement result, the UE may identify the SSB index corresponding to the strongest signal strength or L1-RSRP.

For the bi-directional deployment scenario 102, the TRPs include two-sided antenna panels (or multiple panels) to direct narrow beams in both directions along the track 108. For example, a TRP 110 (Cell 1, TRP3) forms a beam 112 in a first direction with respect to the track 108 and a beam 114 in a second direction with respect to the track 108, and TRP 116 (Cell 2, TRP1) forms a beam 118 in the first direction with respect to the track 108 and a beam 120 in the second direction with respect to the track 108. Thus, a UE on the passing HST 106 may be able to receive the beam 114 from behind the HST 106 and the beam 118 from in front of the HST 106. The UE may have antenna panels (e.g., mounted on the roof of the HST 106) pointed toward and away from the direction of travel of the moving HST 106. The UE switches which antenna panel is active depending on which narrow beam (i.e., beam 114 or beam 118) the UE is currently receiving for beam management and/or data communication.

For the uni-directional deployment scenario 104, the TRPs form beams along a single direction with respect to the track 108. For example, a TRP 122 (Cell 2, TRP1) forms a beam 124 in the direction toward the approaching HST 106. Thus, the UE may use a single antenna panel (e.g., pointed in the general direction of the moving HST 106) for beam management and/or data communication.

When TCI state switching or L1-RSRP measurement is across different TRPs (e.g., RRH sites), large propagation delays may occur in both uni-directional and bi-directional HST deployments using FR2. For example, with Ds of about 700m and an HST traveling around 250 kilometers per hour (km/h), the propagation delay may increase by more than 2 microseconds (μs), which is roughly 3.5 times the cyclic prefix (CP) length in 120 kilohertz (kHz) subcarrier spacing (SCS). When the propagation delay is outside the CP boundary, resynchronization may be required.

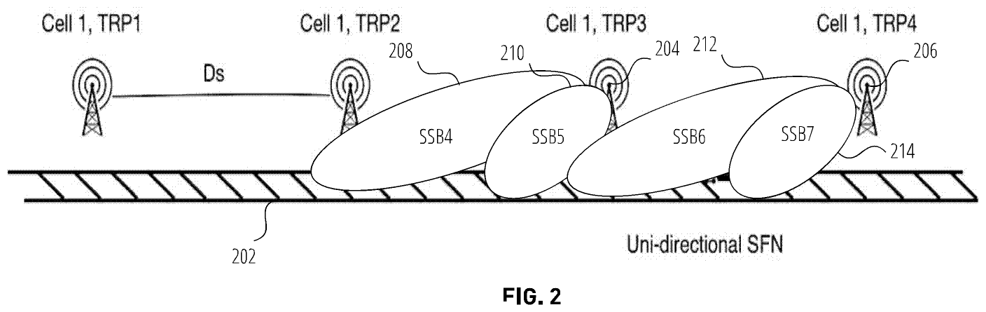

FIG. 2 illustrates an example uni-directional SFN deployment scenario according to one embodiment. In this example, a first cell (Cell 1) includes four TRPs (shown as Cell 1, TRP1; Cell 1, TRP2; Cell 1; TRP3, and Cell 1, TRP4) configured to transmit at least two beams in the same general direction with respect to a track 202. For example, a TRP 204 (Cell 1, TRP3) transmits a synchronization signal block (SSB) using a beam 208 (for SSB index SSB4) and a beam 210 (for SSB index SSB5) in the direction of an oncoming HST (not shown), and TRP 206 (Cell 1, TRP4) transmits SSB using a beam 212 (for SSB index SSB6) and a beam 214 (for SSB index SSB7) in the direction of the oncoming HST. When the UE moves from the beam 210 associated with SSB5 to the beam 212 associated with SSB6, the DL timing suddenly jumps outside the CP boundary such that measurements and switching cannot occur in the adjacent symbols of SSB5 and SSB6. Such jumps in the DL timing associated with inter-TRP or inter-site movement, however, generally do not occur for intra-TRP or intra-site movement (i.e., moving from SSB4 to SSB5 from the same TRP 204).

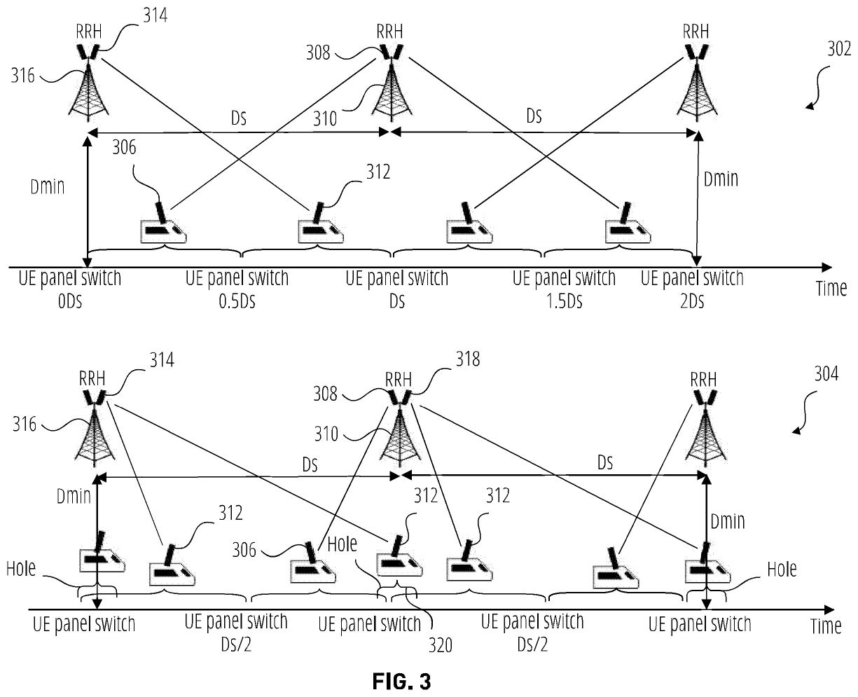

FIG. 3 illustrates example bi-directional SFN deployment scenario according to certain embodiments. In particular, the examples in FIG. 3 include a first bi-directional deployment scheme 302 for connecting to a second nearest RRH (or TRP) and a second bi-directional deployment scheme 304 for connecting to a nearest RRH (or TRP) except when the UE is in a coverage hole of the nearest RRH. An RRH may have a coverage hole, for example, in an area perpendicular to front facing and rear facing antenna panels.

To avoid coverage holes, a UE in the first bi-directional deployment scheme 302 connects using a forward facing antenna panel 306 on the HST to a rear facing antenna panel 308 of an RRH 310, which is the second nearest RRH to the UE at the time. At about 0.5Ds when the UE is closest to the RRH 310, the UE switches the from the forward facing antenna panel 306 to a rear facing antenna panel 312 to connect through a forward facing antenna panel 314 to an RRH 316. Thus, when the UE passes the coverage hole of the RRH 310 it does not lose its connection to the wireless network because the UE is connected through the RRH 316. Thus, the first bi-directional deployment scheme 302 may not suffer from large propagation delay in FR2.

However, UE panel switching in the second bi-directional deployment scheme 304 may cause large propagation delay similar to that of the uni-directional deployment. When the UE is near the RRH 316, the UE connects using the forward facing antenna panel 306 on the HST to the forward facing antenna panel 314 of the RRH 316. As the UE passes the point Ds/2 and becomes nearer to the RRH 310, the UE switches from the rear facing antenna panel 312 to the forward facing antenna panel 306 to connect through the rear facing antenna panel 308 of the RRH 310. However, to provide coverage while in the coverage hole 320 of the RRH 310, the UE switches from the forward facing antenna panel 306 to the rear facing antenna panel 312 to connect through the forward facing antenna panel 314 of the RRH 316. Then, after emerging from the coverage hole 320, the UE disconnects from the RRH 316 and connects the rear facing antenna panel 312 through a forward facing antenna panel 318 of the RRH 310. These disconnections and reconnections over short distances at high speeds using FR1 introduces large propagation delays.

In certain multiple input multiple output (MIMO) systems, a UE performs L1-RSRP measurement based on radio resource configuration (RRC) signaling, e.g., configured in a channel state information (CSI) report configuration message (CSI-reportConf). Since this is RRC configured, the UE measures a large set of L1-RSRP from different RRHs, although many SSBs might not be visible to the UE.

A TCI state includes parameters for configuring a quasi co-location (QCL) relationship between one or more DL reference signals (DLRS) and corresponding antenna ports, e.g., the demodulation reference signal (DMRS) ports of a physical downlink shared channel (PDSCH), the DMRS port of a physical downlink control channel (PDCCH), or the channel state indicator reference signal (CSI-RS) port(s) of a CSI-RS resource set. A UE may be configured with a list of up to M TCI state configurations within the higher layer parameters for decoding the PDSCH according to a detected PDCCH with downlink control information (DCI) for the UE and a given serving cell, where M depends on the capability of the UE. The TCI states may be transmitted to the UE from the network in a medium access layer (MAC) control element (CE), a DCI message, or an RRC activation command. A UE configured with one or more TCI state configurations on a serving cell may be expected to complete the switch of the active TCI state within a specified delay time.

A separate RRC configuration of TCI state list may be used for UE TCI state switching. A MAC CE can update the active TCI State list. The active TCI State list may be used by the UE to maintain fine timing and frequency synchronization of the active TCI state(s). The TCI state list and L1-RSRP RS configuration may be configured separately.

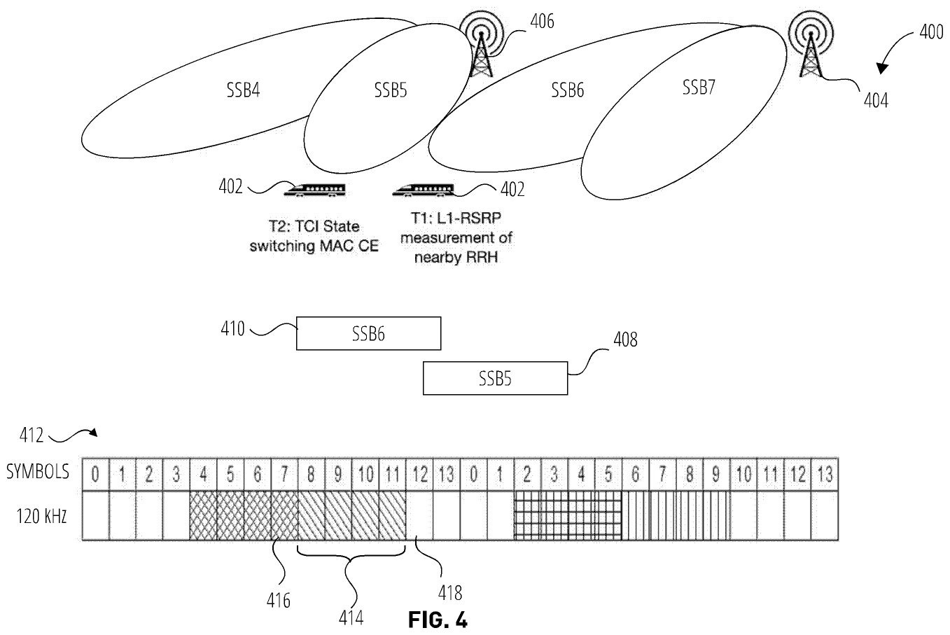

As discussed above, when TCI state switching and/or L1-RSRP measurement is across different TRPs (e.g., RRH sites), large propagation delays may occur in both uni-directional and bi-directional HST deployments using FR2. A large propagation delay may result in overlapping SSB. For example, FIG. 4 illustrates an example scenario 400 for overlapping SSB due to large propagation delay according to certain embodiments. In this example, an RRH 404 transmits SSB in beams corresponding to SSB indexes SSB6 and SSB7, and an RRH 406 transmits SSB in beams corresponding to SSB indexes SSB4 and SSB5. A UE aboard a HST 402 moves away from the RRH 404 toward the RRH 406. When the UE moves from SSB6 to SSB5, at a time T1, the UE performs an L1-RSRP measurement of the nearby RRH 406. At a time T2, the UE receives a TCI state switching MAC CE.

However, as discussed above, the propagation delay may increase by 2 us or more, which is roughly 3.5 times the length in 120 kHz SCS. Thus, the SSB 408 corresponding to SSB index SSB5 arrives at the UE at least partially overlapping in time with the SSB 410 corresponding to the SSB index SSB6. Based on the SSB pattern 412 shown for 120 kHz SCS, the UE may not be able to measure L1-RSRP for SSB5 and SSB6 simultaneously. In other words, because the propagation delay is greater than CP, measuring the four symbols 414 corresponding to SSB6 requires a buffer or gap of a symbol 416 before and a symbol 418 after, which prevents simultaneous L1-RSRP measurement of SSB5 and SSB6. Further, because CSI-reportConfig can configure many SSB for L1-RSRP measurement, multiple SSBs may overlap.

Thus, certain embodiments include a constraint on the network SSB index configuration to prevent or reduce SSBs from overlapping at the UE. In one such embodiment, the network is configured to use non-adjacent SSB indexes for cross-RRH (i.e., inter-RRH). For example, if SSB0 is used for a first RRH, then SSB1 cannot be used for a second RRH. Rather, the network may choose SSB2 or another SSB index for the second RRH. It should be noted, however, that in certain embodiments the network may use adjacent SSB indexes (e.g., SSB0 and SSB1) for the first RRH (intra-RRH).

In another embodiment for avoiding non-adjacent SSB indexes for inter-RRH, when signaling SSB association with RRH, the network reinterprets a mapping group to RRH when an HST FR2 flag is set. For example, in certain implementations an SSBinBurst signaling structure is given by:

```
  ServingCellConfigCommonSIB ::= SEQUENCE {
      ...
```

| | |
|---|---|
| ssb-PositionsInBurst | SEQUENCE { |
| inOneGroup | BIT STRING (SIZE (8)), |
| groupPresence | BIT STRING (SIZE (8)) OPTIONAL -- |

Cond Above6GHzOnly
},....

When the HST flag is set, the network configures SSBs that belong to one group so as to be non-adjacent to SSBs that belong to another group (as identified by the parameter inOneGroup). For example, if SSB0 belongs to group 1 and the HST flag is set, then the network configures SSB2 (rather than SSB1) to group 2.

In another embodiment, the network configures the SSBs to be non-adjacent regardless of inter-RRH or intra-RRH. For example, network uses only even SSB indexes (e.g., SSB0, 2, 4, 6, . . . ) or only odd SSB indexes (e.g., SSB1, 3, 5, 7, . . . ). In addition, or in other embodiments, the network may configure SSBs to be non-adjacent in different component carriers (CCs) within a frequency band or band combination for multi-carrier deployments.

In certain embodiments, when the network constrains the SSB index, the UE assumes no overlapping of SSB for L1-RSRP measurement. Thus, the UE may perform L1-RSRP measurement per SSB burst. In another embodiment, the UE performs L1-RSRP measurement for inter-RRH SSB index with timing acquisition first (e.g., primary synchronization signal (PSS) detection first). For intra-RRH SSB, only secondary synchronization signal (SSS) measurement may be needed since in general orthogonal frequency division multiplexing (OFDM) symbol alignment is assumed.

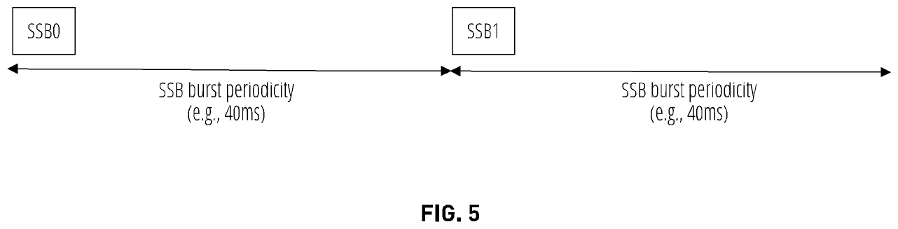

In another embodiment, the UE performs L1-RSRP measurement sharing in inter-RRH SSBs. For example, FIG. 5 illustrates a time division multiplexing (TDM) L1-RSRP measurement of overlapping SSBs according to one embodiment. In this example, the SSB burst periodicity is 40 milliseconds (ms), SSB0 is used for a first RRH, and SSB1 is used for a second RRH. Thus, because the UE cannot measure the overlapping SSBs at the same time, the UE performs TDM L1-RSRP measurement of the overlapping SSBs.

In another embodiment of L1-RSRP measurement sharing, when SSBs from different RRHs are configured in different CSI-reportConfig messages, a measurement window may be configured for some CSI-reportConfig with SSBs from a different RRH. The configuration of the measurement window may include the periodicity, the duration, and/or the slot/symbol offset. The UE then performs TDM L1-RSRP measurement for each SSB index.

In another embodiment, the UE reports the maximum number of different RRHs for the SSBs configured in one CSI-reportConfig. For example, the UE may report that it can only measure one RRH or a maximum of two RRH. Thus, the network may only configure the indicated number of RRHs in the CSI-reportConfig message to simplify the timing management from the UE side.

In another embodiment, a scaling factor K may be configured by higher layer signaling (e.g. RRC) or may be predefined (e.g. K=number of RRHs), for beam failure detection (BFD) interval and/or radio link monitoring (RLM) interval. The beam failure detection interval may be defined as max{2 ms, minimal scaled periodicity of BFD reference signals (RSS)}, where the scaled periodicity for SSB is calculated as K*T, and where Tis the periodicity of SSB. The radio link monitoring interval may be defined as max{10 ms, minimal scaled periodicity of BFD RSs}, where the scaled periodicity for SSB is calculated as K*T, and where T is the periodicity of SSB.

In certain embodiments, the network configures a scheduling restraint for TCI state switching. For example, the network may configure the inter-RRH TCI state not in the active TCI state list. Thus, the UE performs additional SSB acquisition when TCI state switching is between RRHs. The delay for L1-RSRP measurement for receive (Rx) beam refinement (i.e. TBM_Measurement_Period_SSB) to determine the TCI activation delay defined in 3GPP Technical Specification (TS) 38.133, section 8.10.3 may be determined by scaled SSB periodicity (e.g. K*T, where K is the scaling factor configured by gNB or predefined and T indicates the SSB periodicity).

In certain embodiments, the network configures the inter-RRH TCI state in the active TCI state list. The UE may report the maximum number (i.e., 1, 2, . . . ) of different RRHs for the active TCI state list as a UE capability. For example, a UE capability report or message indicating “1” may mean only one RRH (i.e., the serving RRH). In other words, the serving RRH cannot be configured as active TCI. A UE capability indicating “2” may mean two RRHs (i.e., a serving RRH and a next RRH). Alternatively, a UE capability report or message may indicate “Yes” to mean no constraint on the active TCI list or a “No” to mean only TCI in the serving RRH can be configured in the active TCI state list.

Alternatively, all the active TCI states may be from the same RRH, in which case a scheduling constraint may be used. For example, the network may configure a scheduling constraint wherein there is no DL receiving in the last symbol of the slot before the TCI State switching delay ends. In one such embodiment, if the target TCI state is known, upon receiving PDSCH carrying MAC-CE activation command in slot n, the UE is able to receive PDCCH with target TCI state of the serving cell on which TCI state switch occurs at the first slot that is after slot n+T_{HARQ}+3Nₛₗₒₜ^{subframe,μ}+TOₖ*(T_{first-SSB}+T_{SSB-proc})/NR slot length. The UE is able to receive PDCCH with the old TCI state until one symbol before slot n+T_{HARQ}+3Nₛₗₒₜ^{subframe,μ}. Where T_{HARQ} is the timing between DL data transmission and acknowledgement (e.g., as specified in 3GPP TS 38.213); T_{first-SSB} is time to first SSB transmission after MAC CE command is decoded by the UE; the SSB is the QCL-TypeA or QCL-TypeC to target TCI state; T_{SSB-proc}=2 ms; and TOₖ=1 if target TCI state is not in the active TCI state list for PDSCH, 0 otherwise; and u is the SCS.

In another example, the network may configure a scheduling constraint wherein there is no DL receiving in the first symbol of the slot after TCI State switching delay ends. In one such embodiment, if the target TCI state is known, upon receiving PDSCH carrying MAC-CE activation command in slot n, the UE is able to receive PDCCH with target TCI state of the serving cell on which TCI state switch occurs at one symbol after the first slot that is after slot n+T_{HARQ}+3Nₛₗₒₜ^{subframe,μ}+TOₖ*(T_{first-SSB}+T_{SSB-proc})/NR slot length. The UE is able to receive PDCCH with the old TCI state until slot n+T_{HARQ}+3Nₛₗₒₜ^{subframe,μ}. Where T_{HARQ} is the timing between DL data transmission and acknowledgement (e.g., as specified in 3GPP TS 38.213); T_{first-SSB} is time to first SSB transmission after MAC CE command is decoded by the UE; the SSB is the QCL-TypeA or QCL-TypeC to target TCI state; T_{SSB-proc}=2 ms; and TOₖ=1 if target TCI state is not in the active TCI state list for PDSCH, 0 otherwise; and u is the SCS.

In another alternative, the network transmits as normal and the UE skips receiving the last and/or first symbol of the previous slot and performs rate matching in decoding.

In certain embodiments, the UE is configured to autonomously apply UL timing advance (TA) adjustment timing. The propagation delays discussed herein may cause the UL timing to not be aligned. In general, a TA adjustment may be used by the UE to modify (e.g., move earlier) the time of an UL transmission relative to, e.g., the DL transmissions from the base station. This may be done to align the time of receipt of the UL transmission at the base station with the receipt of other UL transmissions from other UEs in communication with the base station (with each UE potentially using a different TA adjustment based on, e.g., its distance from the base station), and/or with the timing used by the base station.

A one time UE autonomous large timing adjustment can be applied when the DL timing is greater than a threshold. In one embodiment, for example, the UE autonomously applies UL timing advance TA adjustment timing when T2−T1>threshold, wherein T1 is defined as the DL timing observed in the last slot of PDSCH received from the old or previous TCI state, and T2 is defined as DL timing observed in the first slot where the UE starts receiving PDCCH and PDSCH from the new TCI state. The UE applies the one time large autonomous TA adjustment at T2. The applied value is (T2−T1)*2.

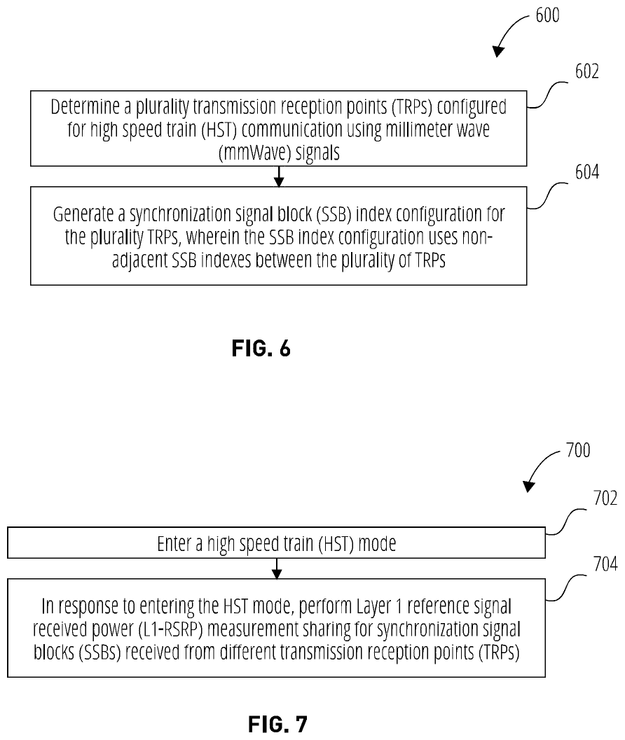

FIG. 6 is a flowchart of a method 600 performed by a cellular communications network according to one embodiment. In block 602, the method 600 includes determining a plurality transmission reception points (TRPs) configured for high speed train (HST) communication using millimeter wave (mmWave) signals. In block 604, the method 600 includes generating a synchronization signal block (SSB) index configuration for the plurality TRPs, wherein the SSB index configuration uses non-adjacent SSB indexes between the plurality of TRPs.

In one embodiment, the method 600 further includes, in response to a flag indicating the HST communication using the mm Wave signals, reinterpreting a mapping group of SSBs associated with the plurality of TRPs such that first SSBs in a first group are non-adjacent to second SSBs in a second group.

In one embodiment of the method 600, the SSB index configuration further uses the non-adjacent SSB indexes for a TRP of the plurality of TRPs. For example, the SSB index configuration consists of even numbered SSB indexes, or the SSB index configuration consists of odd numbered SSB indexes.

In one embodiment of the method 600, the SSB index configuration further uses the non-adjacent SSB indexes across different component carriers (CCs) within a frequency band or frequency band combination.

In one embodiment of the method 600, at least one of the plurality of TRPs comprises a remote radio head (RRH).

Embodiments contemplated herein include an apparatus comprising means to perform one or more elements of the method 600. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 600. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 918 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

FIG. 7 is a flowchart of a method 700 for a UE according to one embodiment. In block 702, the method 700 includes entering a high speed train (HST) mode. In block 704, tin response to entering the HST mode, the method 700 includes performing Layer 1 reference signal received power (L1-RSRP) measurement sharing for synchronization signal blocks (SSBs) received from different transmission reception points (TRPs).

In certain embodiments of the method 700, performing the L1-RSRP measurement sharing comprises performing time division multiplexing (TDM) L1-RSRP measurement of overlapping SSBs received at the UE. The SSBs received from different TRPs may be configured in different channel state information (CSI) report configuration (CSI-reportConfig) messages. At least one of the CSI-reportConfig messages may include a measurement window configuration for the SSBs received from the different TRPs. The measurement window configuration may include at least one of a periodicity, a duration, and a slot or symbol offset of a measurement window.

In one embodiment, the method 700 further includes sending a UE capability report, from the UE to a cellular communications network, to indicate a maximum number of the different TRPs.

In one embodiment, the method 700 further includes using a scaling factor K for at least one of beam failure detection (BFD) interval and radio link monitoring (RLM) interval. The BFD interval comprises max{2 ms, minimal scaled periodicity of BFD reference signals (RSS)}, wherein the scaled periodicity for the SSBs is calculated as K*T, and wherein T comprises a periodicity of the SSBs. The RLM interval comprises max{10 ms, minimal scaled periodicity of BFD reference signals (RSs)}, wherein the scaled periodicity for the SSBs is calculated as K*T, and wherein T comprises a periodicity of the SSBs.

In one embodiment of the method 700, at least one of the TRPs comprises a remote radio head (RRH).

In one embodiment of the method 700, a network configuration of an inter-TRP transmission configuration indication (TCI) state is not in an active TCI state list, and the method further includes performing additional SSB acquisition when TCI state switching is between the different TRPs. A delay for an L1-RSRP measurement may be determined using a scaled SSB periodicity K*T, where K is a scaling factor and T indicates an SSB periodicity.

In one embodiment of the method 700, a network configuration of an inter-TRP transmission configuration indication (TCI) state is in an active TCI state list. The method 700 may further include sending a UE capability report, from the UE to a base station, to indicate a maximum number of the different TRPs for the active TCI state list. Alternatively, all the active TCI states are from a single TRP and the method 700 further includes receiving, by the UE, downlink (DL) data based on a scheduling restraint for TCI state switching, wherein the scheduling restraint comprises no receiving the DL data in a last symbol of a slot before a TCI state switching delay ends. In another embodiment, the scheduling restraint comprises no receiving the DL data in a first symbol of a slot after a TCI state switching delay ends.

In one embodiment, the method 700 further includes: skipping receiving, by the UE, at least one of a last symbol or a first symbol of a previous slot; and performing, by the UE, rate matching in decoding.

In one embodiment, the method 700 further includes: determining when downlink (DL) timing, T2−T1, is greater than a threshold, where T1 corresponds to a last slot of a physical downlink control channel (PDSCH) received by the UE according to an old transmission configuration indication (TCI) state, and where T2 corresponds to a first slot where the UE starts receiving at least one of a physical downlink control channel (PDCCH) and the PDSCH according to a new TCI state; and in response to determining that T2−T1 is greater than the threshold, autonomously applying uplink (UL) timing advance (TA) adjustment timing. The method 700 may further include autonomously applying the UL TA adjusting timing at T2 as a value (T2−T1)*2.

Embodiments contemplated herein include an apparatus comprising means to perform one or more elements of the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 902 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

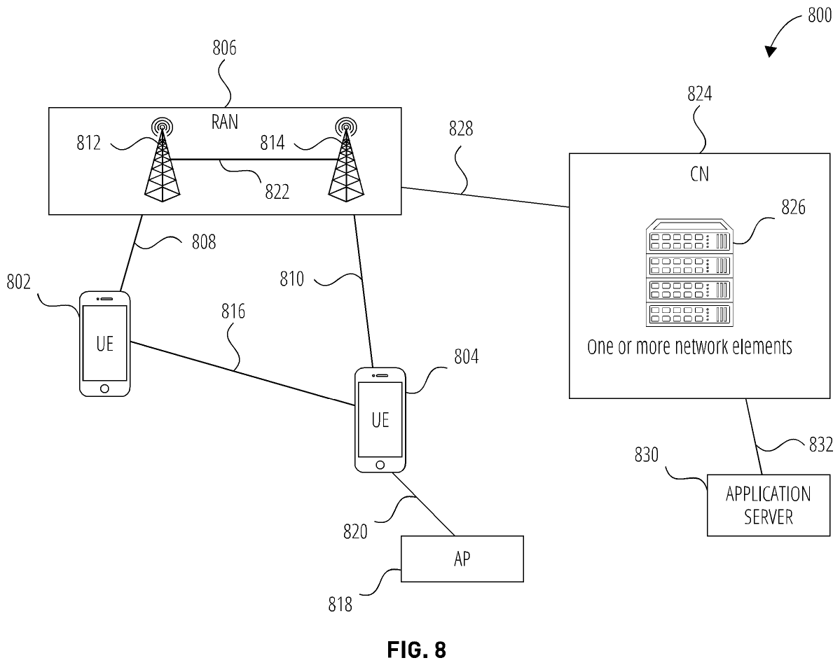

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

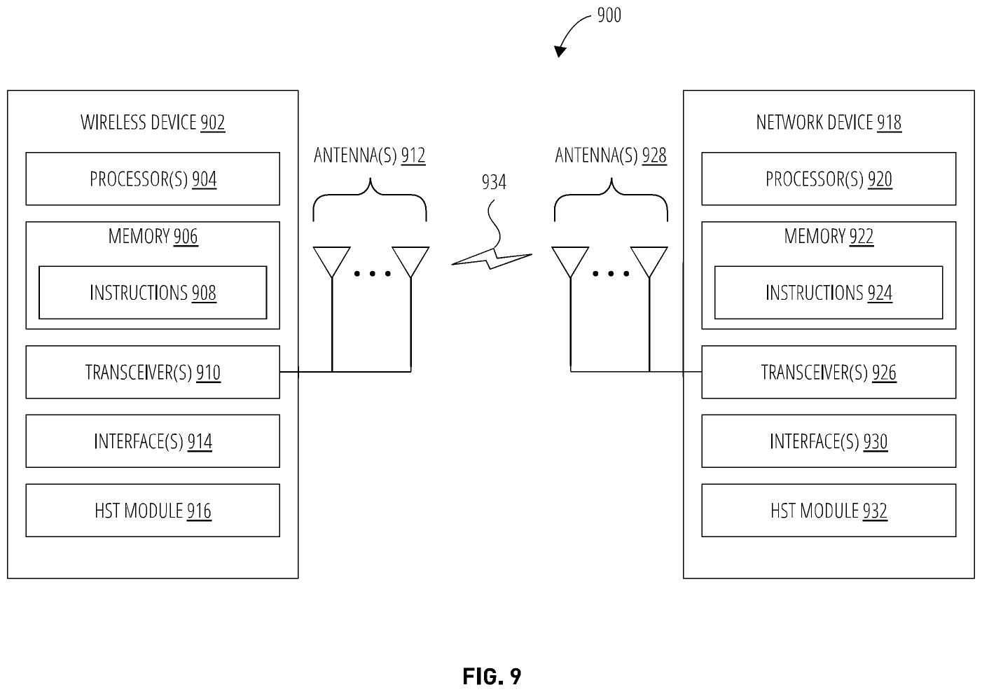

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a HST module 916. The HST module 916 may be implemented via hardware, software, or combinations thereof. For example, the HST module 916 may be implemented as a processor, circuit, and/or instructions 908 stored in the memory 906 and executed by the processor(s) 904. In some examples, the HST module 916 may be integrated within the processor(s) 904 and/or the transceiver(s) 910. For example, the HST module 916 may be implemented by a combination of software components (e.g., executed by a DSP or a general processor) and hardware components (e.g., logic gates and circuitry) within the processor(s) 904 or the transceiver(s) 910.

The HST module 916 may be used for various aspects of the present disclosure, for example, aspects of FIG. 7.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a HST module 932. The HST module 932 may be implemented via hardware, software, or combinations thereof. For example, the HST module 932 may be implemented as a processor, circuit, and/or instructions 924 stored in the memory 922 and executed by the processor(s) 920. In some examples, the HST module 932 may be integrated within the processor(s) 920 and/or the transceiver(s) 926. For example, the HST module 932 may be implemented by a combination of software components (e.g., executed by a DSP or a general processor) and hardware components (e.g., logic gates and circuitry) within the processor(s) 920 or the transceiver(s) 926.

The HST module 932 may be used for various aspects of the present disclosure, for example, aspects of FIG. 6

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a cellular communications network, the method comprising:
determining a plurality transmission reception points (TRPs) configured for high speed train (HST) communication using millimeter wave (mmWave) signals; and
generating a synchronization signal block (SSB) index configuration for the plurality TRPs, wherein the SSB index configuration uses non-adjacent SSB indexes between the plurality of TRPs.

2. The method of claim 1, further comprising, in response to a flag indicating the HST communication using the mmWave signals, reinterpreting a mapping group of SSBs associated with the plurality of TRPs such that first SSBs in a first group are non-adjacent to second SSBs in a second group.

3. The method of claim 1, wherein the SSB index configuration further uses the non-adjacent SSB indexes for a TRP of the plurality of TRPs.

4. The method of claim 3, wherein the SSB index configuration consists of even numbered SSB indexes.

5. The method of claim 3, wherein the SSB index configuration consists of odd numbered SSB indexes.

6. The method of claim 1, wherein the SSB index configuration further uses the non-adjacent SSB indexes across different component carriers (CCs) within a frequency band or frequency band combination.

7. The method of claim 1, wherein at least one of the plurality of TRPs comprises a remote radio head (RRH).

8. A method for a user equipment (UE), the method comprising:
entering a high speed train (HST) mode; and
in response to entering the HST mode, performing Layer 1 reference signal received power (L1-RSRP) measurement sharing for synchronization signal blocks (SSBs) received from different transmission reception points (TRPs).

9. The method of claim 8, wherein performing the L1-RSRP measurement sharing comprises performing time division multiplexing (TDM) L1-RSRP measurement of overlapping SSBs received at the UE.

10. The method of claim 9, wherein the SSBs received from different TRPs are configured in different channel state information (CSI) report configuration (CSI-reportConfig) messages.

11. The method of claim 10, wherein at least one of the CSI-reportConfig messages comprises a measurement window configuration for the SSBs received from the different TRPs.

12. The method of claim 11, wherein the measurement window configuration includes at least one of a periodicity, a duration, and a slot or symbol offset of a measurement window.

13. The method of claim 8, further comprising sending a UE capability report, from the UE to a cellular communications network, to indicate a maximum number of the different TRPs.

14. The method of claim 8, further comprising using a scaling factor K for at least one of beam failure detection (BFD) interval and radio link monitoring (RLM) interval.

15. The method of claim 14, wherein the BFD interval comprises max{2 ms, minimal scaled periodicity of BFD reference signals (RSs)}, wherein the scaled periodicity for the SSBs is calculated as K*T, and wherein T comprises a periodicity of the SSBs.

16. The method of claim 14, wherein the RLM interval comprises max{10 ms, minimal scaled periodicity of BFD reference signals (RSS)}, wherein the scaled periodicity for the SSBs is calculated as K*T, and wherein T comprises a periodicity of the SSBs.

17. The method of claim 8, wherein at least one of the TRPs comprises a remote radio head (RRH).

18. The method of claim 8, wherein a network configuration of an inter-TRP transmission configuration indication (TCI) state is not in an active TCI state list, the method further comprising performing additional SSB acquisition when TCI state switching is between the different TRPs.

19. The method of claim 18, wherein a delay for an L1-RSRP measurement is determined using a scaled SSB periodicity K*T, where K is a scaling factor and T indicates an SSB periodicity.

20. The method of claim 8, wherein a network configuration of an inter-TRP transmission configuration indication (TCI) state is in an active TCI state list.

21-29. (canceled)
